(19) United States
(12) Patent Application Publication
(10) Pub. No.: US 2013/0271672 A1
(43) Pub. Date: Oct. 17, 2013

(54) TELEVISION MANIPULATION METHOD, HANDHELD DEVICE, TELEVISION, AND TELEVISION MANIPULATION SYSTEM

(71) Applicant: Huawei Technologies Co., Ltd., (US)

(72) Inventors: Jian Chen, Shanghai (CN); Shouzhen Lan, Shenzhen (CN); Muzhou Ji, Shanghai (CN); Pingning Li, Shanghai (CN); Di Wu, Shanghai (CN); Fuhai Dong, Shanghai (CN); Hongliang Zhao, Shanghai (CN)

(21) Appl. No.: 13/826,305

(22) Filed: Mar. 14, 2013

(30) Foreign Application Priority Data
Mar. 30, 2012 (CN) 201210090316.5

(51) Int. Cl. H04N 5/44

(52) U.S. Cl. CPC H04N 5/4403
USPC 348/734

(57) ABSTRACT

The present invention discloses a television manipulation method, a handheld device, a television, where in the television manipulation method, the handheld device pre-establishes a connection relationship with a television to be controlled and determines application software to be manipulated, and then a manipulation program corresponding to the application software is installed on the handheld device, so as to implement manipulation on the application software. Through the method, information interaction between the handheld device and the television can be implemented; the handheld device obtains application information of application software installed on the television, and a corresponding manipulation program is installed on handheld device, the handheld device can also obtain application information of application software in a server, a corresponding manipulation program can be installed on the handheld device, and the handheld device implements manipulation on the television after a corresponding application software is installed on the television through the server.

### CROSS-REFERENCE TO RELATED APPLICATION

This application claims priority to Chinese Patent Application No. 201210090316.5, filed on Mar. 30, 2012, which is hereby incorporated by reference in its entirety.

### FIELD OF THE INVENTION

The present invention relates to the field of multi-screen interconnections, and in particular, to a television manipulation method, a handheld device, a television, and a television manipulation system.

### BACKGROUND OF THE INVENTION

At present, with the development of scientific technologies, there are more and more intelligent home appliances and functions thereof become increasingly powerful. For example, a television can not only access the Internet and implement internet surfing, so as to obtain various network resources from the Internet, but also can enable a user to install and uninstall a program, such as software or a game, provided by a third-party service provider, thereby having a function of an entertainment center.

However, when being used on the television, the functions are restricted by an input device. For example, at present, the television mainly uses a remote controller as an input device, but when it is expected to search for network resources or set information on the television, it is complicated and cumbersome to operate by using the remote controller; moreover, when controlling the television, the remote controller gives a control command to the television through an infrared ray, and therefore is restricted by a remote control distance and a remote control angle, thereby failing to implement a remote control and affecting manipulation on the television, so that interaction between the remote controller and the television is poor.

With the wide application of a handheld device such as a smart phone and a palmtop at present, and interaction between the handheld device and the user is increasingly convenient, to overcome the problem that the interaction between the remote controller and the television is poor, the handheld device is usually used as a manipulation terminal, so as to implement the manipulation on the television. In this case, a skilled person needs to install, on the handheld device, a manipulation program corresponding to software on the television, and establish a communication connection between the handheld device and the television through a certain protocol, so as to enable the handheld device to manipulate the television.

However, the inventor finds in a research process of implementing the present invention that, the method of using the handheld device as the manipulation terminal to implement the manipulation on the television in the prior art can only implement unidirectional interaction. Because the handheld device can only implement the manipulation on the television through the manipulation program which is installed therein by the skilled person when the handheld device is delivered from a factory, the manipulation on the television is poor.

### SUMMARY OF THE INVENTION

Accordingly, the objective of the present invention is to provide a television manipulation method, so as to solve the problem in the prior art that a handheld device has a poor manipulation performance when manipulating a television, and a specific solution is as follows:

A television manipulation method includes:

establishing, by a handheld device, a connection relationship with a television;

determining, by the handheld device, application software to be manipulated; and

installing, on the handheld device, a manipulation program corresponding to the application software to be manipulated, so as to implement manipulation on the application software.

Exemplarily, the establishing, by the handheld device, the connection relationship with the television specifically includes:

searching, by the handheld device, for a television to be controlled;

sending, by the handheld device, first response request information to the television that is found; and

receiving, by the handheld device, first device response information sent by the television to the handheld device after the television receives the first response request information, so as to establish a connection relationship with the television; or

sending, by the handheld device, second device response information to the television after receiving second response request information sent by the television, so as to establish a connection relationship with the television.

Exemplarily, the determining, by the handheld device, the application software to be manipulated includes the following step:

receiving, by the handheld device, application information of application software newly installed on the television, so as to determine the application software as the application software to be manipulated by the handheld device.

Exemplarily, the determining, by the handheld device, the application software to be manipulated includes the following steps:

sending, by the handheld device, application request information to the television;

receiving, by the handheld device, application information of application software installed on the television, where the application information is sent by the television to the handheld device after the television receives the application request information and the application information at least includes name information of the application software; and

determining, by the handheld device according to the received application information, application software that has been installed on the television and whose corresponding manipulation program has not been installed on the handheld device, and determining the application software as the application software to be manipulated by the handheld device, where the manipulation program is used to implement manipulation on the application software.

Exemplarily, the determining, by the handheld device, the application software to be manipulated includes the following steps:

establishing, by the handheld device, a network connection with a server;

sending, by the handheld device, query request information to the server that establishes the network connection, so as to query for application software whose manipulation program has not been installed on the handheld device; and

receiving, by the handheld device, application information of the application software that is sent by the server after the server receives the query request information, so as to determine the application software as the application software to be manipulated by the handheld device.

Exemplarily, a method of installing the manipulation program corresponding to the application software to be manipulated on the handheld device specifically includes:

parsing, by the handheld device after determining the application software to be manipulated, the application information corresponding to the application software to be manipulated, so as to install a manipulation program corresponding to the application software to be manipulated; or

sending, by the handheld device, manipulation request information to the server, where the manipulation request information includes application information of the application software to be manipulated by the handheld device; and

receiving, by the handheld device, manipulation information which corresponds to the manipulation request information and is sent by the server after the server receives the manipulation request information, so as to install a manipulation program corresponding to the application software to be manipulated.

Exemplarily, after the installing, on the handheld device, the manipulation program corresponding to the manipulation information, the method further includes:

setting, on an interface of the handheld device, a manipulation icon corresponding to the manipulation program.

A television manipulation method includes:

establishing, by a television, a connection relationship with a handheld device; and

sending, by the television, application information of application software to the handheld device, where the application information at least includes name information of the application software.

Exemplarily, the establishing, by the television, the connection relationship with the handheld device specifically includes:

sending, by the television, first device response information to the handheld device after receiving first response request information sent by the handheld device, so as to establish a connection relationship with the handheld device. or

searching, by the television, for a handheld device;

sending, by the television, second response request information to the handheld device that is found; and

receiving, by the television, second device response information sent by the handheld device to the television after the handheld device receives the second response request information, so as to establish a connection relationship with the handheld device.

Exemplarily, a specific method of sending, by the television, the application information to the handheld device includes:

sending, by the television, application information of newly-installed application software to the handheld device after the new application software is installed; or

sending, by the television after receiving application request information sent by the handheld device, application information of application software installed on the television.

Correspondingly, the present invention discloses a handheld device, including:

a connection relationship establishing module, configured to establish a connection relationship between the handheld device and the television;

a determination module, configured to determine application software to be manipulated by the handheld device; and

an installation module, configured to install a manipulation program corresponding to the application software to be manipulated, so as to implement manipulation on the application software.

Exemplarily, the connection relationship establishing module includes:

a search unit, configured to search for a television to be controlled;

a first sending unit, configured to send first response request information to the television that is found; and

a connection unit, configured to receive first device response information sent by the television to the handheld device, so as to establish a connection relationship with the television; or

a second sending unit, configured to send second device response information to the television after second response request information sent by the television is received, so as to establish a connection relationship with the television.

Exemplarily, the determination module includes:

a first application information receiving unit, configured to receive application information of application software newly installed on the television to be controlled, so as to determine the application software as application software to be manipulated by the handheld device.

Exemplarily, the determination module includes:

a request information sending unit, configured to send application request information to the television to be controlled;

a second application information receiving unit, configured to receive application information of application software installed on the television, where the application information is sent by the television to the handheld device after the television receives the application request information and the application information at least includes name information of the application software; and

a judging unit, configured to determine, according to the received application information, application software that has been installed on the television and whose corresponding manipulation program has not been installed on the handheld device, so as to determine the application software as the application software to be manipulated by the handheld device, where the manipulation program is used to implement manipulation on the application software.

Exemplarily, the determination module includes:

a network connection establishing unit, configured to establish a network connection relationship with a server;

a query request information sending unit, configured to send query request information to the server that establishes the network connection, so as to query for application software whose manipulation program has not been installed on the handheld device; and

a third application information receiving unit, configured to receive application information of the application software that is sent by the server after the server receives the query request information, so as to determine the application software as the application software to be manipulated by the handheld device.

Exemplarily, in the handheld device:

the first sending unit and the second sending unit are the same sending unit or different sending units; and

the first application information receiving unit, the second application information receiving unit, and the third application information receiving unit are the same application information receiving unit, or different application information receiving units.

Exemplarily, the installation module includes:

a parsing and installing unit, configured to: after the application software to be manipulated is determined, parse application information corresponding to the application software to be manipulated, so as to install a manipulation program corresponding to the application software to be manipulated; or

a manipulation request information sending unit, configured to send manipulation request information to the server, where the manipulation request information includes the application information of the application software to be manipulated by the handheld device; and

a receiving and installing unit, configured to receive manipulation information that corresponds to the manipulation request information and is sent by the server after the server receives the manipulation request information, so as to install a manipulation program corresponding to the application software to be manipulated.

Exemplarily, the handheld device further includes:

a setting module, configured to set, on an interface of the handheld device, a manipulation icon corresponding to the manipulation program.

Meanwhile, the present invention discloses a television, including:

a television connection relationship establishing module, configured to establish a connection relationship with the handheld device; and

a television sending module, configured to send application information of application software to the handheld device, where the application information at least includes name information of the application software.

Exemplarily, the television connection relationship establishing module includes:

a first device response information sending unit, configured to send first device response information to a handheld device after first response request information sent by the handheld device is received, so as to establish a connection relationship with the handheld device; or

a television search unit, configured to search for a handheld device;

a second response request information sending unit, configured to send second response request information to the handheld device that is found; and

a second device response information receiving unit, configured to receive second device response information sent by the handheld device to the television after the handheld device receives the second response request information, so as to establish a connection relationship with the handheld device.

Exemplarily, the television sending module includes:

a first television sending unit, configured to send application information of application software installed on the television to the handheld device after application request information sent by the handheld device is received; or

a second television sending unit, configured to send application information of newly-installed application software to the handheld device after the new application software is installed.

Exemplarily, the first television sending unit and the second television sending unit are the same television sending unit or different television sending units.

The present invention discloses a television manipulation system, and the television manipulation system includes: a handheld device and a television, where the handheld device includes: a connection relationship establishing module, a determination module, and an installation module; and the television includes: a television connection relationship establishing module and a television sending module; in addition, the handheld device further includes: a setting module. Moreover, the television manipulation system disclosed by the present invention may further include: a server.

Through the television manipulation method disclosed by the present invention, information interaction between the handheld device and the television can be implemented, where the handheld device obtains the application information of the application software installed on the television, and the corresponding manipulation program is installed on the handheld device, so as to implement the manipulation on the television; meanwhile, the handheld device can also obtain the application information of the application software in the server, the corresponding manipulation program can be installed on the handheld device, and the handheld device implements the manipulation on the television after the corresponding application software is installed on the television through the server, thereby improving manipulation performance of the handheld device on the television.

Particularly, the manipulation interface of the handheld device is set with the manipulation icon corresponding to the manipulation program, so that a user manipulates the television conveniently.

### BRIEF DESCRIPTION OF THE DRAWINGS

To illustrate the technical solutions in the embodiments of the present invention or in the prior art more clearly, the accompanying drawings needed for describing the embodiments or the prior art are briefly introduced in the following. Apparently, the accompanying drawings in the following descriptions merely show some embodiments of the present invention, and persons of ordinary skill in the art may still derive other drawings from the accompanying drawings without creative efforts.

FIG. 1 is a schematic work flow chart of a television manipulation method disclosed by an embodiment of the present invention;

FIG. 2 is a schematic work flow chart of establishing a connection relationship in a television manipulation method disclosed by an embodiment of the present invention;

FIG. 3 is a schematic work flow chart of determining application software to be manipulated in a television manipulation method disclosed by an embodiment of the present invention;

FIG. 4 is a schematic work flow chart of determining application software to be manipulated in another television manipulation method disclosed by an embodiment of the present invention;

FIG. 5 is a schematic work flow chart of installing a manipulation program in a television manipulation method disclosed by an embodiment of the present invention;

FIG. 6 is a schematic work flow chart of establishing a connection relationship in a television manipulation method disclosed by an embodiment of the present invention;

FIG. 7 is a schematic work flow chart of establishing a connection relationship in another television manipulation method disclosed by an embodiment of the present invention;

FIG. 8 is a schematic structural diagram of a handheld device disclosed by an embodiment of the present invention;

FIG. 9 is a schematic structural diagram of a connection relationship establishing module in a handheld device disclosed by an embodiment of the present invention;

FIG. 10 is a schematic structural diagram of a determination module in a handheld device disclosed by an embodiment of the present invention;

FIG. 11 is a schematic structural diagram of a determination module in another handheld device disclosed by an embodiment of the present invention;

FIG. 12 is a schematic structural diagram of an installation module in a handheld device disclosed by an embodiment of the present invention;

FIG. 13 is a schematic structural diagram of a television disclosed by an embodiment of the present invention;

FIG. 14 is a schematic structural diagram of a television connection relationship establishing module in a television disclosed by an embodiment of the present invention; and

FIG. 15 is a schematic structural diagram of a television manipulation system disclosed by an embodiment of the present invention.

### DETAILED DESCRIPTION OF THE EMBODIMENTS

The technical solutions in the embodiments of the present invention are clearly and completely described in the following with reference to the accompanying drawings in the embodiments of the present invention. Apparently, the embodiments to be described are merely a part rather than all of the embodiments of the present invention. All other embodiments obtained by persons of ordinary skill in the art based on the embodiments of the present invention without creative efforts shall fall within the protection scope of the present invention.

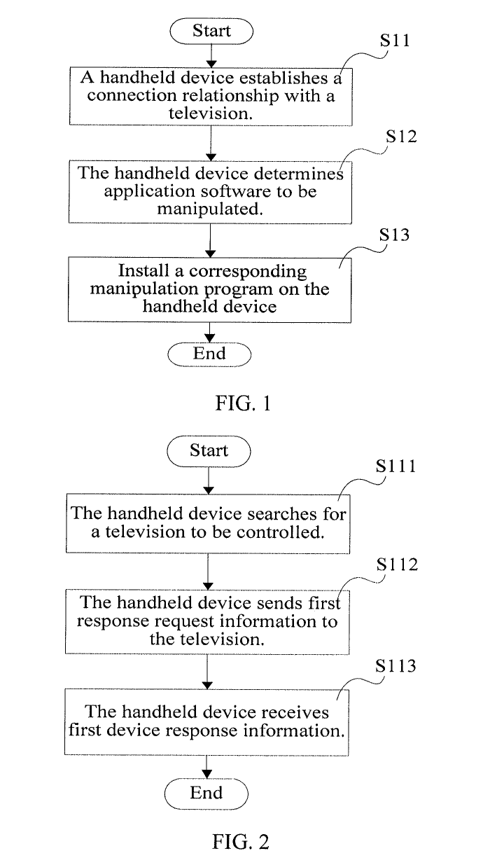

In a conventional method for manipulating a television by using a handheld device, manipulation on the television is just unidirectional manipulation, and the manipulation performance is poor. To solve the problem, the present invention discloses a television manipulation method, and FIG. 1 shows a schematic work flow chart of the method, which specifically includes the following steps:

Step S11: A selected handheld device establishes a connection relationship with a television, where the handheld device may be a smart phone or a palmtop PAD; particularly, multiple handheld devices may be used to implement manipulation on a television, so in step S11, multiple handheld devices may establish a connection relationship with the television.

Step S12: The handheld device determines application software to be manipulated; where a user can install application software such as a game in an existing television to implement function expansion of the television; to manipulate newly-installed application software on the television or to manipulate other application software disclosed by a server, the handheld device needs to determine the application software to be manipulated, and the application software to be manipulated is application software that has been installed on the television or is owned by the server; however, manipulation cannot be implemented on such application software because no corresponding manipulation program is installed on the handheld device.

Step S13: Install, on the handheld device, a manipulation program corresponding to the application software to be manipulated, so as to implement manipulation on the application software through the manipulation program.

Through step S11 and step S13, the handheld device establishes the connection relationship with the television, and the manipulation program of the application software can be installed on the handheld device, to implement the manipulation on the application software.

Referring to FIG. 2, Embodiment 2 disclosed by the present invention discloses specific steps of establishing, by the handheld device, the connection relationship with the television in step S11:

Step S111: The handheld device searches for a television to be controlled.

Step S112: The handheld device sends first response request information to the television that is found, where after completing the searching, to implement the connection with the television to be controlled, the handheld device sends the first response request information to the television, and in this step, if multiple televisions are to be controlled, the handheld device may send the first response request information separately to multiple televisions to be controlled.

Step S113: The handheld device receives first device response information sent by the television to the handheld device after the television receives the first response request information, so as to establish the connection relationship with the television, where after receiving the first response request information, the television to be controlled correspondingly generates the first device response information; the handheld device receives the first device response information, and establishes the connection relationship between the handheld device and the television through a communication network between the handheld device and the television; the communication network may be Ethernet or a 3G network; after the connection relationship is established, information transmission between the handheld device and the television may be implemented; and in addition, the connection relationship is not fixed, and when the connection is not needed, the handheld device and the television may remove the connection relationship unilaterally.

In addition, when a handheld device establishes the connection relationship with multiple televisions, a television list of the multiple televisions may be generated in the handheld device, so as to enable the handheld device to select one or more televisions through the television list to perform the manipulation. In actual manipulation, a manipulation instruction sent by the handheld device includes an identifier of a television to be controlled, so that each television obtains the manipulation instruction sent to each television, respectively, where the identifier of the television may be an IP address of the television, or other identifiers capable of indicating the identity of the television.

In addition, the user of the television end may also take a measure to establish a connection relationship with the handheld device, and in this embodiment, the establishing, by the handheld device, the connection relationship with the television specifically includes:

sending, by the television, second response request information to the handheld device, and sending, by the handheld device, second device response information to the television after receiving the second response request information sent by the television, so as to establish a connection relationship with the television.

In addition, to ensure that the handheld device can manipulate the application software newly installed on the television to be controlled, it needs to determine application software that the handheld device cannot manipulate, namely, whose manipulation program has not been installed, and has been installed on the television, and application software meeting the foregoing requirements is the application software to be manipulated by the handheld device. To determine the application software, Embodiment 3 of the present invention discloses the following method:

When the television to be controlled has newly installed application software, the television sends application information of the application software newly installed therein to the handheld device, so as to determine the application software as the application software to be manipulated by the handheld device.

The determined application software to be manipulated may be a newly-updated advanced version, and a manipulation program of a corresponding early version was once installed on the handheld device. In this case, the early version may be deleted after a manipulation program of the advanced version is installed. For example, when a manipulation program, of an advanced version, of application software is installed, the user may be inquired whether to delete the early version of the manipulation program; or when the advanced version is installed, the early version of the manipulation program in the handheld device is automatically replaced.

In the foregoing manner of determining application software to be manipulated, after every time the television has newly-installed application software, the handheld device can obtain application information of the newly-installed application software, so that the application software to be manipulated can be determined.

In addition, in actual use, the handheld device is not powered on all the time, when the handheld device runs out of power or stops running due to other reasons, the user may install new application software on the television, but after the installation of the newly-installed application software is completed, the handheld device is powered off and therefore cannot obtain application information of the newly-installed application software. To solve this problem, the present invention provides Embodiment 4.

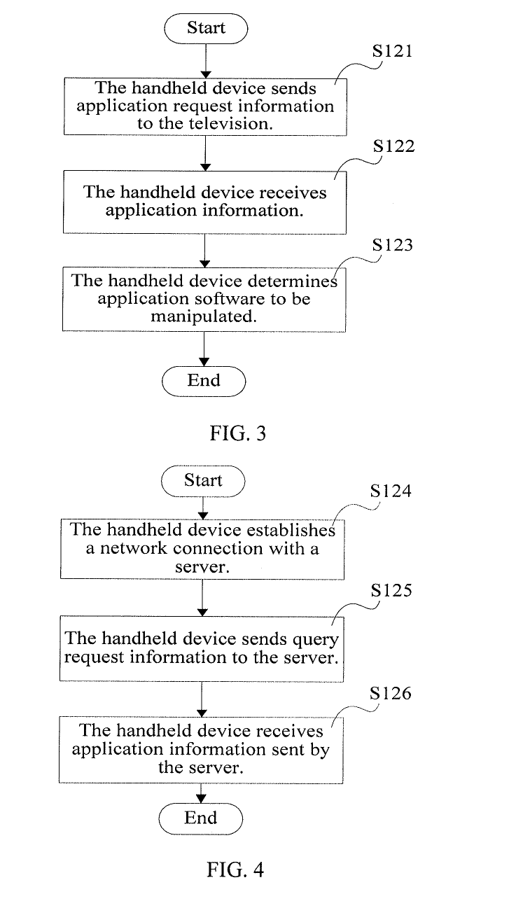

Referring to FIG. 3, Embodiment 4 disclosed by the present invention describes specific steps of another method of determining, by the handheld device, the application software to be manipulated:

Step S121: The handheld device sends application request information to the television.

Step S122: The handheld device receives application information of application software installed on the television that is sent by the television to the handheld device after the television receives the application request information, where the application information at least includes name information of the application software, and in addition, the application information may further include one or more pieces of information of a size, a running version, establishment time, and a provider of the application software.

Step S123: The handheld device determines, according to the received application information, application software that has been installed on the television and whose corresponding manipulation program has not been installed on the handheld device, so as to determine the application software as the application software to be manipulated by the handheld device, where the manipulation program is used to implement manipulation on the application software.

Through step S121 to step S123, the handheld device sends the application request information to the television, so that after receiving the application request information, the television sends the application information of the installed application software to the handheld device, and then the handheld device can determine, according to the application software, the application software to be manipulated. The method is applied to the case where every time after being started, the handheld device obtains the application information of the application software newly installed on the television, and definitely, during a period when the handheld device is started, the method may also be used.

In addition, in the current technical field, though a server has a large amount of application software, the handheld device can also determine application software to be manipulated in the server, where FIG. 4 shows a work flow of determining, by the handheld device, the application software to be manipulated in the server, and the solution includes the following steps:

Step S124: The handheld device establishes a network connection with a server.

Step S125: The handheld device sends query request information to the server that establishes the network connection, so as to query for application software whose manipulation program has not been installed on the handheld device; where in the query process, the handheld device may include information of a manipulation program that has been installed in the sent query request information, so as to query for and determine the application software to be manipulated.

Step S126: The handheld device receives application information of the application software that is sent by the server after the server receives the query request information, so as to determine the application software as application software to be manipulated by the handheld device.

The server has a large amount of application software, through the solution disclosed in step S124 to step S126, the handheld device may query for and obtain the application information of the application software included in the server, so as to install a corresponding manipulation program in a subsequent step. In this case, after the manipulation program installed on the handheld device is obtained by the television, corresponding application software may also be installed on the television through information interaction with the server, so as to implement function expansion of the television.

The method, disclosed by the present invention, of installing the manipulation program corresponding to the application software to be manipulated on the handheld device specifically includes:

after determining the application software to be manipulated, parsing, by the handheld device, the application information corresponding to the application software to be manipulated, so as to install a manipulation program corresponding to the application software to be manipulated.

Through the foregoing method, the handheld device may implement the installation of the corresponding manipulation program by parsing the application information.

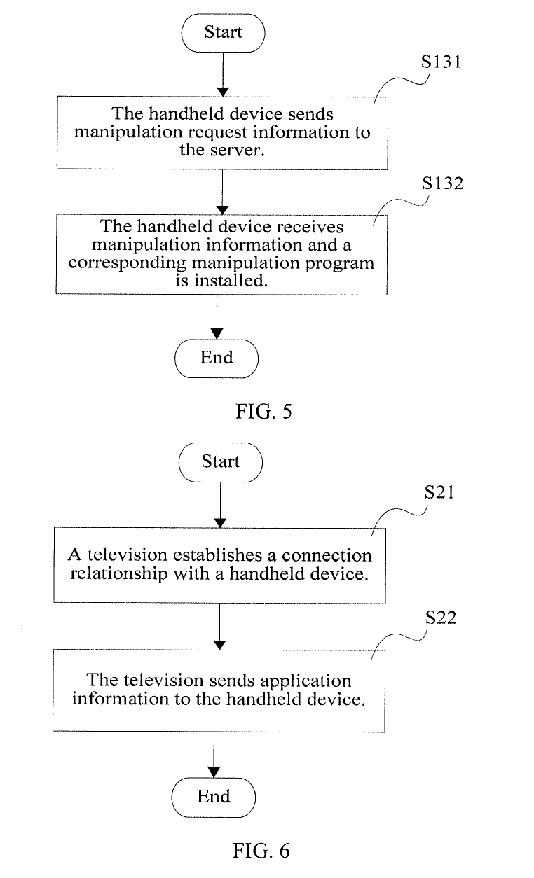

In addition, the present invention further provides another solution to install a manipulation program, and FIG. 5 shows a schematic work flow chart of the solution, specifically including the following steps:

Step S131: The handheld device sends manipulation request information to the server, where the manipulation request information includes application information of the application software to be manipulated by the handheld device; and after receiving the manipulation request information, the server parses the application information therein and obtains corresponding manipulation information.

Step S132: The handheld device receives manipulation information which corresponds to the manipulation request information and is sent by the server after the server receives the manipulation request information, so as to install a manipulation program corresponding to the application software to be manipulated.

Through the solution disclosed in step S131 to step S132, the handheld device sends the application information to the server through information interaction with the server, and the server parses the application information and sends the manipulation information obtained through parsing to the handheld device, so that the handheld device completes the installation of the manipulation program.

In addition, after the handheld device completes the installation of the manipulation program, the solution further includes:

setting, on an interface of the handheld device, a manipulation icon corresponding to the manipulation program, where in the prior art, when a remote controller is used to control the television, only a limited manipulation manner can be provided due to a restriction of a manipulation interface of the remote controller, and when application software such as a game is installed on the television and the application software is manipulated, many restrictions exist; while in the manner disclosed by the present invention, the manipulation icon corresponding to the manipulation program of the application software can be set on the manipulation interface of the handheld device, and while the application software that installed on the television is being manipulated, it is only required to touch the manipulation icons to fulfill the application, so that the user can implement the manipulation on the television through the manipulation icons on the manipulation interface.

Meanwhile, the present invention further discloses a television manipulation method, which is mainly aimed at a television; FIG. 6 shows a schematic work flow chart of the method, and the method includes the following steps:

Step S21: A television establishes a connection relationship with a handheld device.

Step S22: The television sends application information of application software to the handheld device, where the application information at least includes name information of the application software.

In step S21, the establishing, by the television, the connection relationship with the handheld device specifically includes:

sending, by the television, first device response information to the handheld device after receiving first response request information sent by the handheld device, so as to establish a connection relationship with the handheld device.

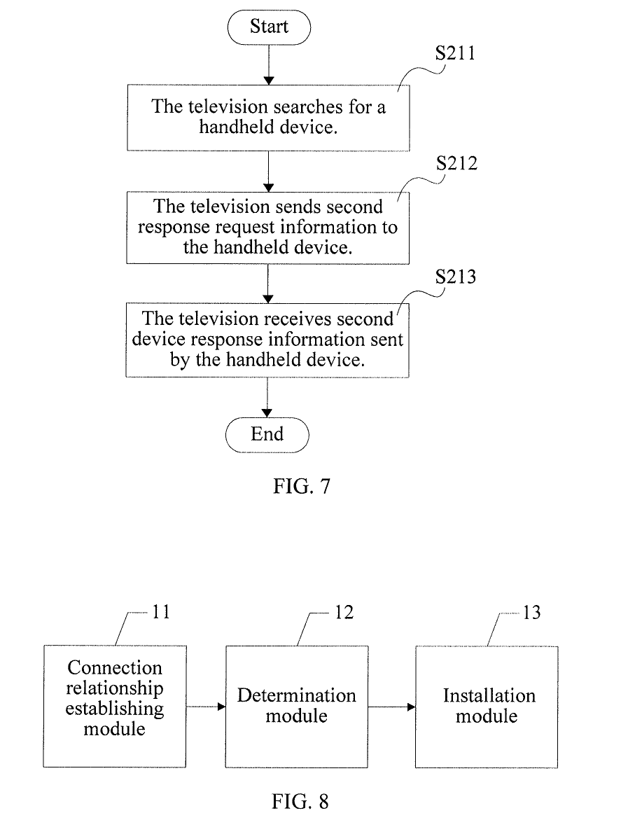

In the foregoing solution, in establishing the connection relationship, the handheld device actively initiates a connection, and the present invention further discloses another embodiment, where the television actively initiates a connection, and FIG. 7 shows a schematic work flow chart of the method, including the following steps:

Step S211: The television searches for a handheld device.

Step S212: The television sends second response request information to the handheld device that is found.

Step S213: The television receives second device response information sent by the handheld device to the television after the handheld device receives the second response request information, so as to establish a connection relationship with the handheld device.

Through the solution disclosed in step S211 to step S213, the connection between the television and the handheld device can be implemented, so as to implement information interaction between the television and the handheld device in a subsequent process.

Meanwhile, a method of sending, by the television, the application information to the handheld device specifically includes:

sending, by the television, application information of newly-installed application software to the handheld device after the new application software is installed.

In the foregoing disclosed solution, after every time the television has newly-installed application software, the television actively sends application information to the handheld device. Meanwhile, the present invention further discloses a solution, including:

sending, by the television after receiving application request information sent by the handheld device, application information of application software installed on the television.

Correspondingly, the present invention discloses a handheld device, and FIG. 8 shows a schematic structural diagram of the handheld device, including: a connection relationship establishing module 11, a determination module 12, and an installation module 13, where

the connection relationship establishing module 11 is configured to establish a connection relationship between the handheld device and the television;

the determination module 12 is configured to determine application software to be manipulated by the handheld device; and

the installation module 13 is configured to install a manipulation program corresponding to the application software to be manipulated, so as to implement manipulation on the application software.

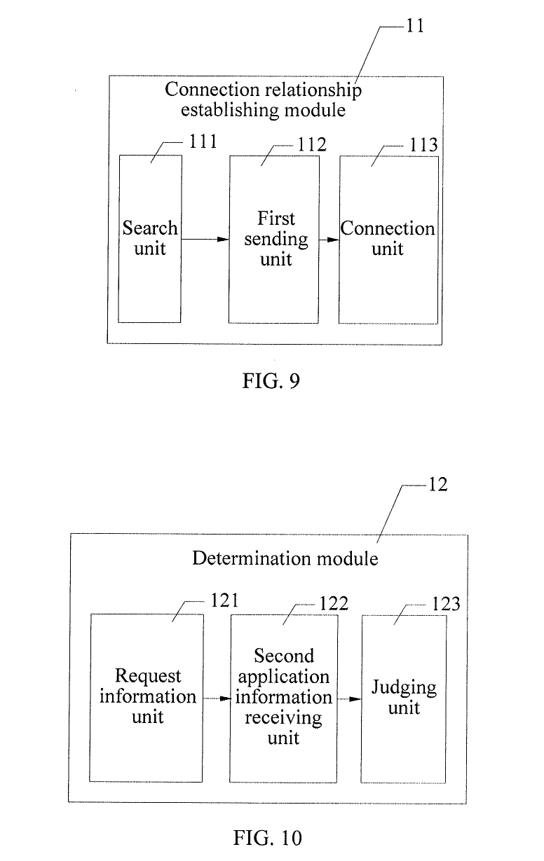

Specifically, referring to FIG. 9, the connection relationship establishing module 11 includes: a search unit 111, a first sending unit 112, and a connection unit 113, where the search unit 111 is configured to search for a television to be controlled, where

in actual application, the handheld device may implement manipulation on multiple televisions, so the module may search for multiple televisions to be controlled;

the first sending unit 112 is configured to send first response request information to the television that is found; and

the connection unit 113 is configured to receive first device response information sent by the television to the handheld device, so as to establish the connection relationship with the television.

Alternatively, the connection relationship establishing module 11 includes: a second sending unit, configured to send second device response information to the television after second response request information sent by the television is received, so as to establish the connection relationship with the television.

In addition, the first sending unit 112 and the second sending unit may be two different sending units in the handheld device and execute their respective operations, and may be the same sending unit with the function of sending the first device response information and the second device response information.

Specifically, the determination module 12 includes: a first application information receiving unit, where the first application information receiving unit is configured to receive application information of application software newly installed on the television to be controlled, so as to determine the application software as application software to be manipulated by the handheld device.

Alternatively, referring to FIG. 10, the determination module 12 includes: a request information sending unit 121, a second application information receiving unit 122, and a judging unit 123, where

the request information sending unit 121 is configured to send application request information to the television to be controlled;

the second application information receiving unit 122 is configured to receive application information of application software installed on the television, where the application information is sent by the television to the handheld device after the television receives the application request information and the application information at least includes a name of the application software; in addition, the application information may further include one or more pieces of information of a size, a running version, establishment time, and a provider of the application software; and

the judging unit 123 is configured to determine application software that has been installed on the television and whose corresponding manipulation program has not been installed on the handheld device, so as to determine the application software as the application software to be manipulated by the handheld device, where the manipulation program is used to implement manipulation on the application software.

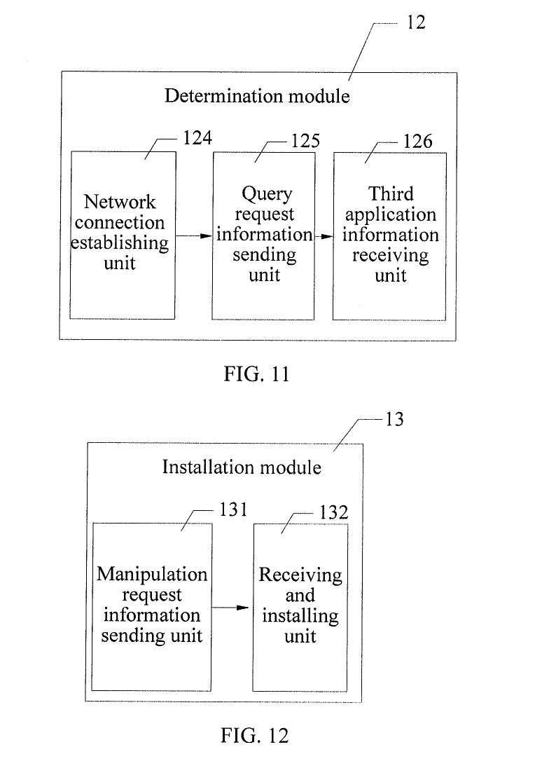

Alternatively, referring to FIG. 11, the determination module 12 includes: a network connection establishing unit 124, a query request information sending unit 125, and a third application information receiving unit 126, where

the network connection establishing unit 124 is configured to establish a network connection relationship with a server;

the query request information sending unit 125 is configured to send query request information to the server that establishes the network connection, so as to query for application software whose manipulation program has not been installed on the handheld device; and

the third application information receiving unit 126 is configured to receive application information of the application software that is sent by the server after the server receives the query request information, so as to determine the application software as the application software to be manipulated by the handheld device.

In addition, the first application information receiving unit, the second application information receiving unit 122, and the third application information receiving unit 126 may be different application information receiving units in the handheld device and execute their respective operations, and may also be the same application information receiving unit with the function of receiving the application information.

Specifically, the installation module 13 includes: a parsing and installing unit, and the parsing and installing unit is configured to: after the application software to be manipulated is determined, parse the application information corresponding to the application software to be manipulated, so as to install a manipulation program corresponding to the application software to be manipulated.

Alternatively, referring to FIG. 12, the installation module 13 includes: a manipulation request information sending unit 131 and a receiving and installing unit 132, where

the manipulation request information sending unit 131 is configured to send manipulation request information to the server, where the manipulation request information includes the application information of the application software to be manipulated by the handheld device; and

the receiving and installing unit 132 is configured to receive the manipulation information which corresponds to the manipulation request information and is sent by the server after the server receives the manipulation request information, so as to install a manipulation program corresponding to the application software to be manipulated.

In addition, the handheld device further includes: a setting unit, configured to set, on an interface of the handheld device, a manipulation icon corresponding to the manipulation program, so as to implement manipulation on the application software installed on the television.

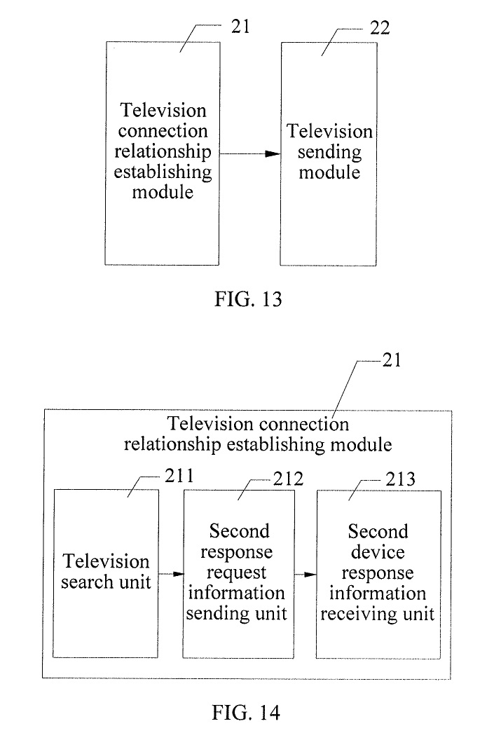

Correspondingly, the present invention discloses a television, and FIG. 13 shows a schematic structural diagram of the television, including: a television connection relationship establishing module 21, and a television sending module 22, where

the television connection relationship establishing module 21 is configured to establish a connection relationship with the handheld device; and

the television sending module 22 is configured to send application information of application software to the handheld device, where the application information at least includes name information of the application software.

The television connection relationship establishing module 21 includes: a first device response information sending unit, configured to send first device response information to a handheld device after first response request information sent by the handheld device is received, so as to establish a connection relationship with the handheld device.

Alternatively, FIG. 14 shows a schematic structural diagram of the television connection relationship establishing module 21, including:

a television search unit 211, configured to search for a handheld device;

a second response request information sending unit 212, configured to send second response request information to the handheld device that is found; and

a second device response information receiving unit 213, configured to receive second device response information sent by the handheld device to the television after the handheld device receives the second response request information, so as to establish a connection relationship with the handheld device.

The television sending module 22 includes: a first television sending unit, configured to send application information of application software installed on the television to the handheld device after application request information sent by the handheld device is received.

Alternatively, the television sending module 22 includes: a second television sending unit, configured to send application information of newly-installed application software to the handheld device after the new application software is installed.

In addition, the first television sending unit and the second television sending unit may be different television sending units in the handheld device and execute their respective operations, and may also be the same television sending unit with a television sending function.

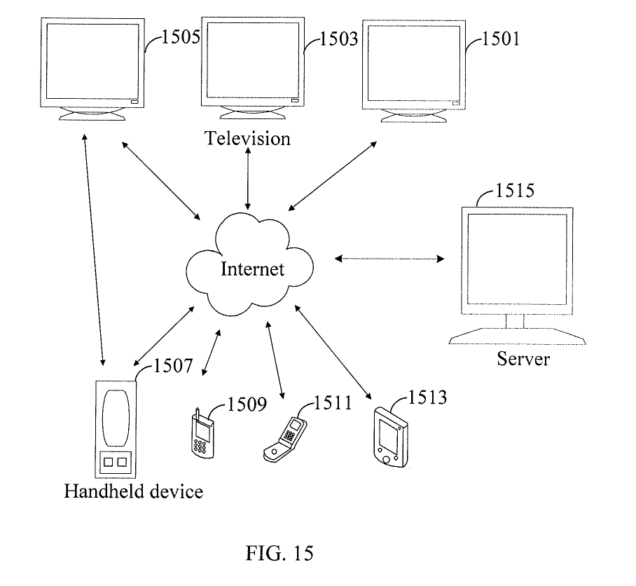

Meanwhile, the present invention further discloses a television manipulation system. FIG. 15 shows a schematic structural diagram of the system, and the television manipulation system includes: handheld devices 1507, 1509, 1511, and 1513, and televisions 1501, 1503, and 1505, where each handheld device includes: a connection relationship establishing module, a determination module, and an installation module; and the television includes: a television connection relationship establishing module and a television sending module; in addition, the handheld device further includes: a setting module. Moreover, the television manipulation system disclosed by the present invention may further include: a server 1515.

It should be noted that, the handheld device includes but is not limited to: a handle game machine, a smart phone, and a palmtop.

It should be noted that, the handheld device may communicate with one television to manipulate the television, and may also communicate with multiple televisions to synchronously manipulate the multiple televisions.

It should be noted that, the handheld device may directly establish communication with the television through an infrared or a wifi module, and may also be first connected to the internet and then establish the communication connection with the television, or adopt other existing network connection manners.

Through the television manipulation method disclosed by the present invention, information interaction between the handheld device and the television can be implemented, where the handheld device obtains the application information of the application software installed on the television, and the corresponding manipulation program is installed on the handheld device, so as to implement the manipulation on the television; meanwhile, the handheld device can also obtain the application information of the application software in the server, the corresponding manipulation program can be installed on the handheld device, and the handheld device implements the manipulation on the television after the corresponding application software is installed on the television through the server, thereby improving manipulation performance of the handheld device on the television

Particularly, the manipulation interface of the handheld device is set with the manipulation icon corresponding to the manipulation program, so that the user manipulates the television conveniently.

Persons of ordinary skill in the art may be aware that, in combination with the examples described in the embodiments disclosed in this specification, units and algorithm steps can be implemented by electronic hardware, or a combination of computer software and electronic hardware. Whether the functions are executed by hardware or software depends on particular applications and design constraint conditions of the technical solutions. Persons skilled in the art may use different methods to implement the described functions for each particular application, but it should not be considered that the implementation goes beyond the scope of the present invention.

It may be clearly understood by persons skilled in the art that, for the purpose of convenient and brief description, for a detailed working process of the foregoing system, apparatus, and unit, reference may be made to a corresponding process in the method embodiments, and details are not described here again.

In the embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. A part or all of the units may be selected according to an actual need to achieve the objectives of the solutions of the embodiments.

In addition, each functional unit in each embodiment of the present invention may be integrated into one processing unit, or each of the units may exist alone physically, or two or more units are integrated into one unit.

When the functions are implemented in the form of a software functional unit and sold or used as a separate product, the functions may be stored in a computer-readable storage medium. Based on such an understanding, the technical solutions of the present invention essentially, or the part contributing to the prior art, or part of the technical solutions may be implemented in the form of a software product. The computer software product is stored in a storage medium, and includes several instructions for instructing a computer device (which may be a personal computer, a server, a network device, and the like) to execute all or part of the steps of the method described in the embodiment of the present invention. The storage medium includes: any medium that can store program code, such as a U-disk, a removable hard disk, a read-only memory (ROM, Read-Only Memory), a random access memory (RAM, Random Access Memory), a magnetic disk, or an optical disk.

The preceding description disclosed in the embodiments allows persons skilled in the art to implement or use the present invention. Multiple modifications to these embodiments are apparent for persons skilled in the art. The general principle defined in the present invention may be implemented in other embodiments without departing from the spirit or scope of the present invention. Therefore, the present invention is not to be limited to the embodiments described in the document but extends to the widest scope that complies with the principle and novelty disclosed in the document.

What is claimed is:

1. A television manipulation method, comprising:
establishing, by a handheld device, a connection relationship with a television;
determining, by the handheld device, application software to be manipulated; and
installing, on the handheld device, a manipulation program corresponding to the application software to be manipulated, so as to implement manipulation on the application software.

2. The method according to claim 1, wherein the establishing, by the handheld device, the connection relationship with the television specifically comprises:
searching, by the handheld device, for a television to be controlled;
sending, by the handheld device, first response request information to the television that is found; and
receiving, by the handheld device, first device response information sent by the television to the handheld device after the television receives the first response request information, so as to establish a connection relationship with the television; or
sending, by the handheld device, second device response information to the television after receiving second response request information sent by the television, so as to establish a connection relationship with the television.

3. The method according to claim 1, wherein the determining, by the handheld device, the application software to be manipulated comprises:
receiving, by the handheld device, application information of application software newly installed on the television, so as to determine the application software as the application software to be manipulated by the handheld device.

4. The method according to claim 1, wherein the determining, by the handheld device, the application software to be manipulated comprises:
sending, by the handheld device, application request information to the television;
receiving, by the handheld device, application information of application software installed on the television, wherein the application information is sent by the television to the handheld device after the television receives the application request information and the application information at least comprises name information of the application software; and
determining, by the handheld device according to the received application information, application software that has been installed on the television and whose corresponding manipulation program has not been installed on the handheld device, and determining the application software as the application software to be manipulated by the handheld device, wherein the manipulation program is used to implement manipulation on the application software.

5. The method according to claim 1, wherein the determining, by the handheld device, the application software to be manipulated comprises:
establishing, by the handheld device, a network connection with a server;
sending, by the handheld device, query request information to the server that establishes the network connection, so as to query for application software whose manipulation program has not been installed on the handheld device; and
receiving, by the handheld device, application information of the application software that is sent by the server after the server receives the query request information, so as to determine the application software as the application software to be manipulated by the handheld device.

6. The method according to claim 3, wherein a method of installing, on the handheld device, the manipulation program corresponding to the application software to be manipulated specifically comprises:
parsing, by the handheld device after determining the application software to be manipulated, the application information corresponding to the application software to be manipulated, so as to install a manipulation program corresponding to the application software to be manipulated; or
sending, by the handheld device, manipulation request information to the server, wherein the manipulation request information comprises application information of the application software to be manipulated by the handheld device; and
receiving, by the handheld device, manipulation information that corresponds to the manipulation request information and is sent by the server after the server receives the manipulation request information, so as to install a manipulation program corresponding to the application software to be manipulated.

7. The method according to claim 1, wherein after the installing, on the handheld device, the manipulation program corresponding to the manipulation information, the method further comprises:
setting, on an interface of the handheld device, a manipulation icon corresponding to the manipulation program.

8. A handheld device, comprising:
a connection relationship establishing module, configured to establish a connection relationship between the handheld device and the television;
a determination module, configured to determine application software to be manipulated by the handheld device; and
an installation module, configured to install a manipulation program corresponding to the application software to be manipulated, so as to implement manipulation on the application software.

9. The handheld device according to claim 8, wherein the connection relationship establishing module comprises:
a search unit, configured to search for a television to be controlled;
a first sending unit, configured to send first response request information to the television that is found; and
a connection unit, configured to receive first device response information sent by the television to the handheld device, so as to establish a connection relationship with the television; or
a second sending unit, configured to send second device response information to the television after second response request information sent by the television is received, so as to establish a connection relationship with the television.

10. The handheld device according to claim 8, wherein the determination module comprises:
a first application information receiving unit, configured to receive application information of application software newly installed on the television to be controlled, so as to determine the application software as application software to be manipulated by the handheld device.

11. The handheld device according to claim 8, wherein the determination module comprises:
a request information sending unit, configured to send application request information to the television to be controlled;
a second application information receiving unit, configured to receive application information of application software installed on the television, wherein the application information is sent by the television to the handheld device after the television receives the application request information and the application information at least comprises name information of the application software; and
a judging unit, configured to determine, according to the received application information, application software that has been installed on the television and whose corresponding manipulation program has not been installed on the handheld device, so as to determine the application software as the application software to be manipulated by the handheld device, wherein the manipulation program is used to implement manipulation on the application software.

12. The handheld device according to claim 8, wherein the determination module comprises:
a network connection establishing unit, configured to establish a network connection relationship with a server;
a query request information sending unit, configured to send query request information to the server that establishes the network connection, so as to query for application software whose manipulation program has not been installed on the handheld device; and
a third application information receiving unit, configured to receive application information of the application software that is sent by the server after the server receives the query request information, so as to determine the application software as the application software to be manipulated by the handheld device.

13. The handheld device according to claim 9, wherein
the first sending unit and the second sending unit are the same sending unit or different sending units; and
the first application information receiving unit, the second application information receiving unit, and the third application information receiving unit are the same application information receiving unit, or different application information receiving units.

14. The handheld device according to claim 10, wherein the installation module comprises:
a parsing and installing unit, configured to: after the application software to be manipulated is determined, parse application information corresponding to the application software to be manipulated, so as to install a manipulation program corresponding to the application software to be manipulated; or
a manipulation request information sending unit, configured to send manipulation request information to the server, wherein the manipulation request information comprises the application information of the application software to be manipulated by the handheld device; and
a receiving and installing unit, configured to receive manipulation information that corresponds to the manipulation request information and is sent by the server after the server receives the manipulation request information, so as to install a manipulation program corresponding to the application software to be manipulated.

15. The handheld device according to claim 8, wherein the handheld device further comprises:
a setting module, configured to set, on an interface of the handheld device, a manipulation icon corresponding to the manipulation program.

16. A television, comprising:
a television connection relationship establishing module, configured to establish a connection relationship with the handheld device; and
a television sending module, configured to send application information of application software to the handheld device, wherein the application information at least comprises name information of the application software.

17. The television according to claim 16, wherein the television connection relationship establishing module comprises:
a first device response information sending unit, configured to send first device response information to a handheld device after first response request information sent by the handheld device is received, so as to establish a connection relationship with the handheld device; or
a television search unit, configured to search for a handheld device;
a second response request information sending unit, configured to send second response request information to the handheld device that is found; and
a second device response information receiving unit, configured to receive second device response information sent by the handheld device to the television after the handheld device receives the second response request information, so as to establish a connection relationship with the handheld device.

18. The television according to claim 16, wherein the television sending module comprises:
a first television sending unit, configured to: after application request information sent by the handheld device is received, send application information of application software installed on the television to the handheld device; or
a second television sending unit, configured to send application information of newly-installed application software to the handheld device after the new application software is installed.

19. The television according to claim 18, wherein the first television sending unit and the second television sending unit are the same television sending unit or different television sending units.
